(19) United States
(12) Patent Application Publication
(10) Pub. No.: US 2010/0060640 A1
(43) Pub. Date: Mar. 11, 2010

(54) INTERACTIVE ATMOSPHERE - ACTIVE ENVIRONMENTAL RENDERING

(75) Inventors: Garen Melikian, Greenwich, CT (US); Arman Boshyan, Yerevan (AM)

Correspondence Address: Kaplan Gilman & Pergament LLP, 1480 Route 9 North, Woodbridge, NJ, 07095, US

(73) Assignee: Memco, Inc., Greenwich, CT (US)

(21) Appl. No.: 12/492,129

(22) Filed: Jun. 25, 2009

Related U.S. Application Data
(60) Provisional application No. 61/075,385, filed on Jun. 25, 2008.

(51) Int. Cl. G06T 15/20

(52) U.S. Cl. 345/427

(57) ABSTRACT

In the field of rendering a three dimensional model into a two dimensional graphical representation, the resources available to a general purpose computer can be used to efficiently render the scene. The high speed/low computer resource with which the rendering is performed results from utilizing different inputs to the rendering engine and from the manner in which the rendering engine handles these inputs.

### FIELD OF THE INVENTION

The present invention is in the field of rendering a three dimensional model into a two dimensional graphical representation utilizing the limited computer resources available to a general purpose computer. The high speed/low computer resource with which the rendering is performed results from utilizing different inputs to the rendering engine and from the manner in which the rendering engine handles these inputs.

### BACKGROUND OF THE INVENTION

Rendering generates an image from a model by means of computer software. The starting point, i.e. the model, is a description of a three dimensional (“3D”) object in a defined language or data structure. The language or data structure contains information on geometry, viewpoint, texture, lighting, and shading. Rendering is one of the major sub-topics of 3D computer graphics and is the last major step in the graphics pipeline, giving the final appearance to the models and animation. As computer graphics became more sophisticated, rendering became more and more important and absorbed a greater proportion of emphasis in the graphics pipeline.

Rendering is utilized in video games, interior design, architecture and entertainment video special effects, with different emphasis on techniques and features applicable to each. Animation software packages include a modeling and a rendering engine. A rendering engine utilizes optics, physics, human visual perception, mathematics and software development in creating video graphics. Due to its complexity, rendering is often performed slowly and may be handled through pre-rendering. Pre-rendering is a computationally intensive process that is typically used for movie creation or other non-interactive applications, i.e. where the graphics is ‘still’ or proceeds without intervention via a user or other computer program. Real-time rendering, i.e. rendering including changes via a user or other computer program, is necessarily utilized in video games. Real-time rendering typically relies upon the combination of software and graphics cards with 3D hardware accelerators. High quality real time rendering in 3D has become more economically feasible with growing memory and computing capabilities.

A pre-image is completed first, including a wireframe model of one or more components. Typically, the wireframe model is made up of many polygons. At its most basic, a polygon model is a mesh of triangles and quadrangles fully representing each viewable surface of the modeled objects. Once the pre-image is complete, rendering adds textures, lighting effects, bump mapping and relative position to other objects. The rendered image possesses a number of visible features. Simulation of these features is the focus of advances in rendering.

Rendering terms include: shading—variation of the color and brightness of a surface with lighting; texture-mapping—applying detail to surfaces; bump-mapping simulating small bumps on surfaces; fogging/participating medium—dimming of light when passing through an atmosphere containing suspended particulates; shadows—obstructions interfering with light; soft shadows—varying darkness caused by partially obscured light sources; reflection—mirror-like or highly glossy redirection of light; transparency vs. opacity transmission of light vs. absorption/reflection of light; translucency—transmission of light through solid objects with substantial scattering; refraction—transmission of light through medium that alters speed of transmitted light; diffraction—bending, spreading and interference of light passing by an object or aperture that disrupts the ray; indirect illumination—illumination by light other than directly from light source (also known as global illumination); caustics—a type of indirect illumination, including reflection of light off a shiny object, or focusing of light through a transparent object, to produce bright highlights on another object; depth of field—objects appear blurry or out of focus when too far in front of or behind the object in focus; motion blur—objects appear blurry due to high-speed motion, or the motion of the camera; non-photorealistic rendering—rendering of scenes in an artistic style, intended to look like a painting or drawing.

Numerous algorithms have been developed and researched for rendering software. Such software employs a number of different techniques to obtain a final image. While tracing every ray of light in a scene is impractical and would take an enormous amounts of time, this is the ideal since this is essentially what the human eye does. Even tracing a large enough portion to acquire an image approximating human vision can take a great amount of time if the sampling is not intelligently restricted. Thus, four motifs of efficient light transport modeling have emerged: rasterisation—projects the objects of a scene to form an image, with no facility for generating a point-of-view perspective effect; ray casting—observes the scene from one point-of-view, calculating only geometry and very basic optical laws of reflection intensity, and perhaps using Monte Carlo techniques to reduce artifacts; radiosity—uses finite element mathematics to approximate diffuse spreading of light from surfaces; and ray tracing—similar to ray casting, but employing more advanced optical simulation, and usually uses Monte Carlo techniques to obtain more realistic results at a speed that is often orders of magnitude slower. Advanced software typically combines two or more of the techniques to obtain good-enough results at reasonable cost.

For purposes of speed, a model to be rendered necessarily contains elements in a different domain from basic video picture elements (“pixels”). These elements are referred to as primitives. In 3D rendering, triangles and polygons in space are often the utilized primitives. The rendering engine loops through each primitive, determines which pixels in the image it affects, and modifies those pixels accordingly. This is called rasterization, and is the rendering method used by all current graphics cards. Rasterization is faster than pixel-by-pixel rendering primarily because areas, perhaps even a majority, of the image has no primitives; rasterization, unlike pixel-by-pixel, is able to skip these areas. In addition, rasterization improves cache coherency and reduces redundant work by taking advantage of the fact that the pixels occupying a single primitive can often be treated identically. Thus, rasterization is typically utilized when interactive rendering is required. This does not change the fact that pixel-by-pixel rendering produces higher-quality images and is more versatile, relying on less presumptions than an approach relying on primitives.

At its most basic, rasterization renders an entire face (viewed primitive surface) as a single color. However, a greater level of detail may be achieved by rendering the vertices of a primitive and then rendering the pixels of that face as a blending of the vertex colors. Although such a method utilizes greater resources than basic rasterization it is still far simpler than pixel-by-pixel and it allows the graphics to flow without complicated textures. Textures are used with a face-by-face rasterized image to compensate for block-like effects. It is possible to use one rasterization method on some faces and another method on other faces based on the angle at which that face meets other joined faces, resulting in increased speed and at minimal image degradation costs.

Ray casting is used for real time simulations, e.g. computer games and cartoon animations, where need for detail is outweighed by need to ‘fake’ details to obtain better rendering performance. The resulting surfaces can appear ‘flat’. The model is parsed pixel-by-pixel, line-by-line, from the point of view (“POV”) outward, as if casting rays out from the POV. Pixel color may be determined from a texture-map. A more sophisticated method modifies the color by an illumination factor. Averaging a number of rays in slightly different directions may be used to reduce artifacts. Simulations of optical effects may also be employed, e.g. calculating a ray from the object to the POV and/or calculating the angle of incidence of rays from light sources. Another simulation that may be combined with these simulations uses a radiosity algorithm to plot luminosity.

Radiosity (also known as global illumination) methods simulate the way in which illuminated surfaces act as indirect light sources for other surfaces and produces more realistic shading. The physical basis for radiosity is that diffused light from a given point on a given surface is reflected in a large spectrum of directions and illuminates the area around it. Advanced radiosity simulation coupled with a high quality ray tracing algorithm results in convincing realism, particularly for indoor scenes. Due to the iterative/recursive nature of the technique, i.e. each illuminated object affects the appearance of its neighbors and vice versa, scenes including complicated objects absorb huge computing capacity. Advanced radiosity utilization may be reserved for particular circumstances, e.g. calculating the ambiance of the room without examining the contribution that complex objects make to the radiosity. Alternatively, complex objects may be replaced in the radiosity calculation with simpler objects of similar size and texture.

Ray tracing is an extension of scanline rendering and ray casting and handles complicated objects well. Unlike scanline and casting, ray tracing is typically based on averaging a number of randomly generated samples from a model, i.e. Monte Carlo based. The randomly generated samples are imaginary rays of light intersecting the POV from the objects in the scene. Ray tracing is sometimes used where complex rendering of shadows, refraction or reflection are needed. In high quality ray trace rendering, a plurality of rays are shot for each pixel, and traced through a number of ‘bounces’. Calculation of each bounce includes physical properties such as translucence, color, texture, etc. Once the ray encounters a light source or otherwise dissipates, i.e. ceases to contribute substantially to the scene, then the changes caused by the ray along the rays path are evaluated to estimate a value observed at the POV. Ray tracing is usually too slow to consider for real-time and only useful for production pieces with large lead times. However, efforts at calculations optimizing have led to wider use of ray tracing.

The Rendering Equation is a key concept in rendering. It is a formal expression of the non-perceptual aspect of rendering. Rendering algorithms in general can be seen as solutions to particular formulations of this equation:

$${L}_{O} ( x , \vec{w} ) = {L}_{e} ( x , \vec{w} ) + {\int }_{Ω}^{ } {f}_{r} ( x , {\vec{w}}^{′} , \vec{w} ) {L}_{i} ( x , {\vec{w}}^{′} ) ( {\vec{w}}^{′} \cdot \vec{n} ) d {\vec{w}}^{′}$$

As calculated by the Rendering Equation, the outgoing light (Lₒ) at a particular position and direction, is the sum of the emitted light (Lₑ) and the reflected light (sum of incoming light (Lᵢ) from all directions multiplied by surface reflection and incoming angle). This equation represents the entire ‘light transport’ in a scene, i.e. all movement of light.

Obviously, given the foregoing, the computing resources necessary for ‘real time’ rendering of a scene containing more than several objects of even vaguely complicated structure are extremely high and, still, beyond the standard home computers and laptops utilized by average users. Even high-end general purpose computers provided with expensive video graphics card may not provide the necessary resources. Adding “high quality”, i.e. approaching photo-realism, to the above parameters further increases the necessary computing resources over and above those currently generally available and likely to be available in the not too distant future.

### SUMMARY OF THE INVENTION

Interactive Atmosphere Active Environmental Render is referred to herein as “ia AER”. As the name suggests, ia AER differs from all classical approaches to rendering, but it also distinguishes itself from what has come to be known as volume rendering. The objective of ia AER as a process is to allow rendered scene to be viewable and accessible in real-time while also making it completely interactive, i.e. modifiable. Our objective differs from classical rendering methods, because the objective is not to simply render a frame or map, our objective is to render the entire volume or environment as a 3D space. In order to make offline render available in real-time, such as in gaming industry applications, the real-time render functions are supported by and carried out by the hardware and software rendering algorithms. However, in order to produce high quality images in real-time, the offline method first renders in high quality, then it produces light maps of various objects in the scene to gain realism, it then sends the entire readymade scene to be viewed as a “real-time” scene with the aid of the available hardware and software renderings.

The present ia AER is a powerful and fast rendering invention oriented to real-time and interactive viewing. The ia AER can produce from both fast speed and low bandwidth quality scenes up to photorealistic rendered scenes; it is oriented to real-time and interactive view without any video card dependency—unlike all classical physical lighting rendering methods. The ia AER is a “real” 3D rendering engine, because it does not render the “frame” factor. In fact ia AER does not work around the concept of a frame; it processes the entire environment with which it is presented. The rendered volume can then be viewed from and interacted with in any angle within the environment, even from sides that are invisible to the camera. This means that we are not limited to a fixed “viewpoint” but can easily and immediately “walk-around” the entire scene in high quality 3D imagery, but also to interact and modify the objects that are “already” rendered.

In ia AER the volume of a 3D scene is rendered for each 3D point available in the volume. Once the scene or environment is volume rendered, the scene is available for real-time view, where each frame corresponds to the normal rendered image.

The ia AER defines a cubical volume, which captures contents of the scene. In fact our scene is described as a set of 3D points in a cube. This render method is not based on a viewpoint; it renders the entire environment and the volume points in the scene.

### BRIEF DESCRIPTION OF THE DRAWINGS

FIG. 1 is a 2D rendering of a 3D scene with an overlay of a Cartesian coordinate system and showing three vectors of the coordinate system;

FIG. 2 is a 2D rendering of a 3D scene;

FIG. 3 is a 2D rendering of a 3D scene;

FIG. 4 is a 2D rendering of a 3D scene with an overlay of a Cartesian coordinate system, showing three vectors and further features of the coordinate system;

FIG. 5 is a 2D rendering of a perspective view of a 3D object;

FIG. 6 is a 2D rendering of a perspective view of a 3D polygon;

FIG. 7 is a 2D rendering of a 3D scene with vector information;

FIG. 8 is a 2D rendering of a simplified light vector example;

FIG. 9 is a 2D rendering of a 3D scene of a desktop;

FIG. 10 is a 2D rendering of a 3D scene of a bedroom;

FIG. 11 is a 2D rendering of a 3D scene of a different bedroom;

FIG. 12 is a 2D rendering of a 3D scene of a dining area;

FIG. 13 is a 2D rendering of a 3D scene showing various shapes and vectors;

FIGS. 14a and 14b are different perspectives of the same surface;

FIGS. 15a and 15b are different vector effects on the same 3D object;

FIG. 16 is a volume and effect of rendering such volume using three different points;

FIG. 17 is illustrative volume surfaces;

FIG. 18 is a flowchart showing the logic of a scene rendering;

FIG. 19 is a flowchart showing the logic of the compressed scene; and

FIG. 20 is a flowchart showing a method of adaptive 3D compression.

### DETAILED DESCRIPTION OF THE INVENTION

The ia AER was developed as a research project for engendering cases, in order to understand how a given geometry and the ensuing modeling were constructed.

In the case of classical render engines all the objects in the viewpoint are included by default in the rendering process and everything else outside of the viewport are excluded. In ia AER by contrast, you must include by choice the objects that are to be rendered and ia AER renders the volume and projects it to an object.

The projected ia AER map is NOT a light map, it contains the following information:
1. Light scattering information
2. Shadow placement information
3. Light reflex information
4. Interference information
5. Noise factor information
6. And other additional factors such as bump and texturing flow information
   This unique methodology then amalgamates the collected information of all 6+ factors and then merges it in a single JPEG file.

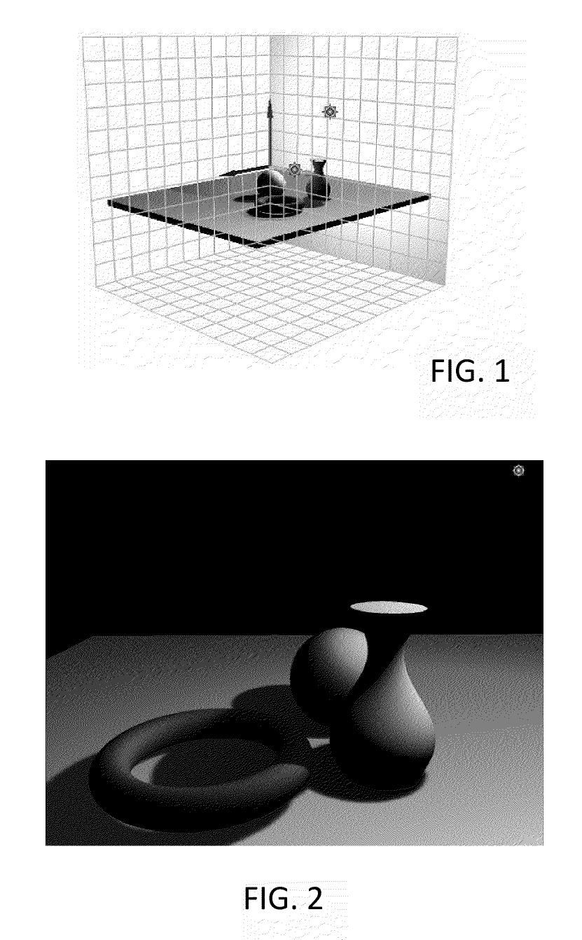

CUBICAL VOLUME AND ORIENTATION POINT: Each scene is placed in the cubical volume, as seen in FIG. 1. However, light 1 is used as projection orientation point. Light 1 may also be placed in the center of the cube if it is so desired. The ia AER projects a volume to the objects placed in the scene; this projection begins and is depends on/is computed from the primary light source, i.e. light 1. As can be seen in FIG. 2 the sides that are ‘visible’ to light 1 are illuminated. So, light 1 is formally named as AER (VR) center with “VR” short for volume render. For some specific cases such as flat objects and faceted objects, orientation of light 1 is not necessary. For faceted projection, all sides of the objects are projected. However to make efficient use and optimize the processor and the RAM, the best method to render the scene is to orient it to the single point AER (VR) center. This avoids unnecessary calculations and the use of extended memory. Rendering of the scene can be performed part by part. You can include or exclude any object in the AER process. By default, all objects are excluded from the AER process. This allows manually choosing which object is necessary for correct, which can be simulated by texture or alternative manual methods.

Because ia renders the volume which then can be viewed in real-time, i.e. the AER process takes time but the amount of time is different from classical and traditional rendering methods. The ia AER's rendering time is much faster than the time it takes the traditional rendering engines to produce similar renders. It renders from 100 to 1000 frames depending on scene complexity and volume zones. This means that if ia AER takes 20 minutes, it would render about 400 classical method frames and for complex scenes about 1000 “classical” frames. However, ia AER is considered much faster when one factors in that the “entire” scene has been rendered not just the viewpoint. Rendering of very complex scenes with light scattering, reflex, and GI factors would usually takes about 10 minutes.

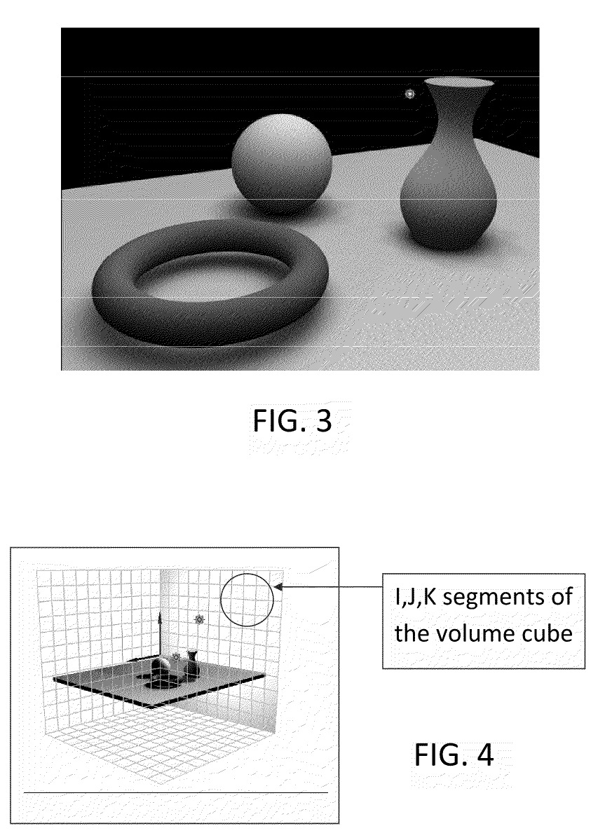

FIG. 3 illustrates an example of rendering of four objects oriented from Light 1. Light 1 represents the light source. We provide here a simple example of rendering. In this example there is no light scattering. But we can see that shadows and lighting is computed correctly on all objects (even in the case of a curved one). After rendering you can walk in the scene to see it from all available viewpoints. This example contains approximately 30,000 polygons.

FIG. 3 shows a complex lighting example where the ambient light is created based on 60 light sources. Light scattering is computed correctly and shadows are constructed as in real-life ambiant lighting by multiple light sources including light 1. The scene is still available in real-time and viewable from any viewpoint after rendering.

DEFINITIONS: Before detailed description of ia AER we must define some terms for generating accurate volume renders used herein.
1. Volume cube—bounding box of the scene to be rendered
2. Volume resolution—number of segments into which volume is divided for example 1024×1024×1024
3. Active volume—non-empty parts of a volume cube that contains objects or lighting effects visible from various viewpoints
4. ia AER (VR) center—varies the volume center to which objects will be visible to the user. ia AER (VR) centers helps to exclude unnecessary parts from the volume cube and generate a more accurate Active volume depending on the scenes complexity and viewing requirements. For example if we have a sofa near the wall, then there is no need to render the back side or the bottom of the sofa because it is not going to be visible to the user in the current scene.
5. ia AER (VR) objects—set of 3D objects included in the visible render and available in the active volume.
6. Lighting sources—full set of light sources or lighting objects that defines the lighting of the scene
7. Output volume matrix—output data of the AER which is a 3D matrix containing lighting information calculated for Active volume
8. ia AER (VR) maps—an optional advanced method which allows the conversion of some parts of the active volume into the volume render light maps form in order to make the scene available for real-time in other engines such as OpenGL or DirectX or to allow texture based lighting in the scene. The map is named the AER (VR) map because it contains lighting information of the volume for the given space of an object and completely recovered to original lighting by merging it with existing light sources used for rendering the volume before.
9. Volume viewer—a program that allows viewing the volume matrix in real-time output.

The present invention is generally achieved as follows:
1. Define a volume cube (bounding box) that includes the whole scene or part of the scene to be rendered
2. Divide the volume cube into segments depending on volume resolution choices (selected by the user)
3. Exclude from the volume cube unnecessary parts such as empty spaces that does not have any visible object and/or light effect
4. Finally define active area of the volume cube, i.e. the active volume
5. Render the active volume and produce an output volume matrix
6. Transfer output volume into real-time view by using is AER (VR) maps or volume viewer
   The algorithm will only render the Active volume.

THE METHOD OF DEFINING VOLUME CUBE: The following steps are used to define the volume cube, it is simply finding of the bounding box of the scene or scene fragment:
1. Find minimum and maximum X, Y, Z coordinates of the scene or selected scene fragment
2. Define bounding box (Xₘᵢₙ, Yₘᵢₙ, Zₘᵢₙ; Xₘₐₓ, Yₘₐₓ, Zₘₐₓ)

THE METHOD OF DIVIDING THE VOLUME CUBE INTO SEGMENTS: This is accomplished by the following steps:
1. Define the size of the delta step to divide the volume into segments, e.g. Δx=(Xₘₐₓ−Xₘᵢₙ)/(resolution factor for x).
2. For each Δx, Δy, Δz in a volume width/height/depth produce Output Matrix [i][j][k] as a 3D matrix containing zero (no lighting) for the first phase.
3. Define OutputMatrixDeltaBoundaries[i][j][k] records where each i,j,k entry contains boundary information for given Δ segment of the volume cube. This is necessary to make the calculation of active volume easier.
4. Indexes i,j,k define 3D position of the segments in the volume cube. Actual coordinates of each i,j,k segment is defined as follows:

X=Xₘᵢₙ+i*Δx

Y=Yₘᵢₙ+j*Δy

Z=Zₘᵢₙ+k*Δz

The width, height and depth of each segment are equal to Δx, Δy, Δz for that segment.

DEFINING AN ACTIVE AREA OF THE VOLUME (ACTIVE VOLUME): This task allows defining an active volume, which means that all the unnecessary parts will be excluded from the rendering process. This process is dependent on the existence of is AER (VR) center.

First stage: Fill the Output Matrix ACTIVE field to false, for each I,J,K segments. The ACTIVE field is used to define whether a segment is active or not. By default all segments are inactive. There are 2 methods to define an active volume.

Method #1:

For each object in the scene do

If object exists in the bounding box do

For each polygon of the object do
(in case if VR center exists, check if polygon is visible from VR
center)
If polygon bounding box is smaller than volume cube segment

delta then attach whole polygon to segment

else

For each point of the polygon surface do

Check to which volume segment the point should be assigned

(find by simple formula (surfaceX − minX)% delta)

Method #2 (simple method):

For each I,J,K segment in the volume cube do

For each object do

(in case if VR center exists, check if polygon is visible from VR

center)

For each surface point do

If point inside the I,J,K segment boundary box than

attach it to segment

Second stage: Fill the Output Matrix ACTIVE field to true for each I,J,K segment in case if segment has an attached point or polygon.

THE METHOD OF RENDERING ACTIVE VOLUME CUBE: The rendering process uses the following:
1. Lighting sources and scene material information
2. Lighting calculation uses known method for computing lighting or external rendering engine for computing lighting for a given point. This can be an external rendering engine or is rendering engine which uses lighting calculation for a given point present in the scene by classical rendering methods.

For each segment in the volume cube

If segment is active do

For each point attached to segment do
{

Calculate lighting output for each R,G,B channel
Compute average lighting for the segment and store it in

the OutputMatrix[i] [j] [k]
}

MORE DETAILS ABOUT LIGHTING CALCULATIONS: The following C++ algorithm shows how multiple lighting sources are computed for a given volume fragment:

miaWriteLog(“Constructing ia AER surface”);

allLightList.List−>DeleteAll( );
allLightList.List−>AddItems(LightList.List);
allLightList.List−>AddItems(&giLights);
objectLightList.List−>DeleteAll( );
if (!GlobalVRCheckForErrors)

for (int i=0; i<LightList.List−>count; i++)
{

PLight lt=LightList.Get(i);
if(lt−>active)

if(lt−>object!=NULL)

objectLightList.List−>AddItems(lt-

>getAttachedObjectLightList( ));

}
allLightList.List−>AddItems(objectLightList.List);

for (int ln=0; ln<allLightList.List−>count; ln++)
{

if (!allLightList.Get(ln)−>UseShadowEffects) continue;
if (!allLightList.Get(ln)−>active) continue;
PLight lt=allLightList.Get(ln);
GlobalIlluminationCalc=false;
miaWriteLog(“Calculating light scattering info:”,s1);
miaClrShowMessageDirectTop(((string)”Calculating light
scattering
info:”)+s1,RGB(203,217,222),0,screenX,screenY,40);

// REFER to external rendering engine or to ia internal rendering engine for computing
light

lt−>BuildShadowDepthInformation(obj,(iFlags &

SHADOW_CUSTOMORIENTED),1.2/coef*coef2)!=0;

}
for (int i=0; i<LightList.List−>count; i++)
{

PLight lt=LightList.Get(i);
if(lt−>object!=NULL)

SetTmpVisible(lt−>object,true,0);

}
pminX = maxint;
pminY = maxint;
pmaxX = −maxint;
pmaxY = −maxint;
ClearBitmap( );
miaWriteLog(“Calculating volume projection”);
miaClrShowMessageDirect(“Calculating volume projection”,”ia AER is

active”,RGB(203,217,222),0,screenX,screenY+screenY/3);

ComputeRotatedVP( );
incr(RenderNumber,1);
browseObj−>CalcPlanes(true,true);
GlobalIlluminationCalc=false;
////////////// here is interpolated rendering of object
/// check for scattering parameter in order to interpolate each light level
for (int ln=0; ln<LightList.List−>count; ln++) //disable all light sources

LightList.Get(ln)−>Enable(false);

QuickSort(obj−>Col,0,obj−>Col−>count-1); //sort all planes by back Z-order
GlobalLightLayerNumber=1;
for (int ln=0; ln<LightList.List−>count; ln++) //render each interpolated light

source as separate layer

{

PLight lt=LightList.Get(ln);
if(lt−>active)

if (lt−>scattering>=1)
{

lt−>Enable(true);
incr(RenderNumber,1);
obj−>Draw( );
if (pminX!=maxint)
{

GlobalLightLayerNumber++;
if (pminX<0) pminX=0;
if (pmaxX>GetGMX( )) pmaxX=GetGMX( );
if (pminY<0) pminY=0;
if (pmaxY>GetGMY( )) pmaxY=GetGMY( );
ActiveLightNum=−1;
miaWriteLog(“Interpolating volume projection”);

}
lt−>Enable(false);

}

}
for (int ln=0; ln<LightList.List−>count; ln++)

//enable all non-interpolated light sources

{

PLight lt=LightList.Get(ln);
if(lt−>active)

if (lt−>scattering<1)
{

lt−>Enable(true);
lightsExists=true;

}

}
GlobalIlluminationCalc=true;
if (lightsExists)
{

SetZBuf( );
obj−>Draw( );

}
// finally enable all lights
for (int ln=0; ln<LightList.List−>count; ln++) //enable all light sources
{

PLight lt=LightList.Get(ln);
lt−>Enable(true);

}

TRANSFORMING RENDERED VOLUME TO ia AER (VR) MAPS: The task is to generate AER maps from rendered volume. This is necessary to make scene available for viewing outside of ia for viewers such as OpenGL or DirectX. ia supports 3 various types of surfaces. The first 2 types are used for specific cases that will be described below:

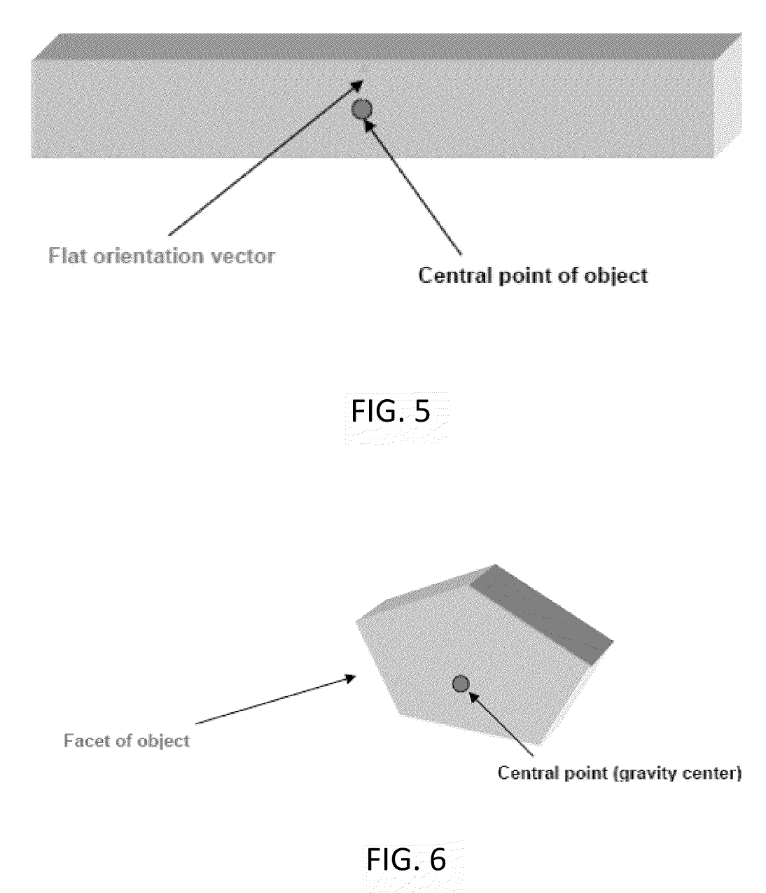

Flat object (orientation independent)—for objects that can be treated as flat. It means that “center” of object has some nearest plane that is “flat” orientation plane. See, e.g., FIG. 5. The flat object can be also “curved” but with generic look as flat. Rendering: In case the object is “flat”, it renders only geometrically correct shadows (as projection) with shadows gradient and smoothness parameters simulation parameters. This flat object surface is also used for flat mirror objects, especially for reflection ray-tracing. This is done in order to free up memory and processing for objects that are to be rendered in ia AER.

Faceted object (orientation independent)—for objects that have “faceted” view. In fact ia treats this as a set of “flat” objects. When faceted objects are included in ia AER, it will be rendered for each polygon from all sides. See, e.g., FIG. 6. This is useful for building shadows on interior walls, where all walls are connected to a single object. It is also useful for rendering columns in the interior or some objects that must be rendered from each side. Rendering: In case the object is “faceted”, it renders only geometrically correct shadows to each facet (as projection) while preserving the shadows gradient and smoothness parameters.

ia AER object—for any logically understandable object—not a fragment of some small object—will be oriented to ia VR center (light 1) in order to compute the volume projection. An ia AER object is dependent on the position of light 1, but it still contains all of its unique rendering information (shadows, lighting, scattering etc).

In fact in most cases Flat and Faceted understanding of objects as described above are not used. ia AER objects are acceptable for most cases even for flat and faceted cases. Therefore, ia AER saves much more memory and resource usage than all the other available methods.

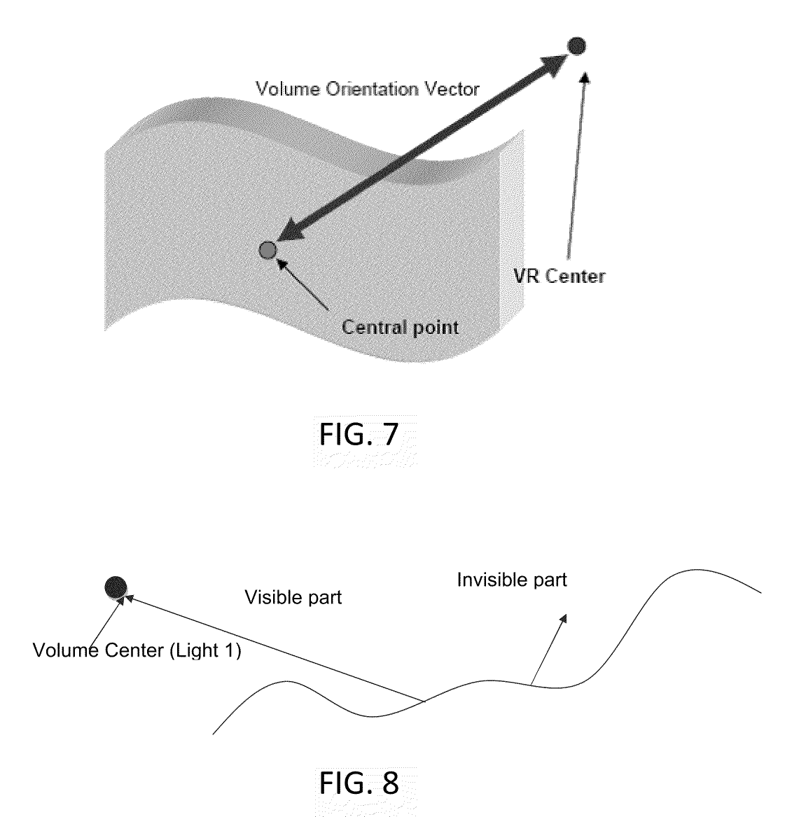

FIG. 7 shows a generic surface mapped in the present invention. In order to generate AER map for a given surface it's necessary to do the following:
Unwrap the object to different parts by any available Unwrap method.
For each unwrapped part
   For each point on the unwrapped part of the surface
      Find to witch segment the point is attached in the volume cube
      Write RGB value of lighting calculation result to X, Y value transformed to A,B,C average normal vector of the surface or to the volume orientation vector defined by AER center point.
         The volume will be projected to all sides of the object including sides that are invisible to light 1. This is useful for some curved surfaces such as cushions, where in fact, the surface is totally visible to Light 1, but some of its polygons are facing the other direction. In the following example, the surface is visible to light 1, but some parts are invisible, we want to map the “dark” part (where there is no lighting) to the invisible parts. This will help keep the original lighting of the object—dark, and therefore for it to come to light when moving a light source over it or adding a regular light in the final scene. The visible and invisible surfaces are apparent and can be used for projecting to the entire object. See, e.g., FIG. 8.

DISPLAYING ia AER (VR) MAPS: AER maps looks like light maps containing RGBA information about each pixel on the surface. However, AER correctly computes only if the original light source is present. The process of merging of original light source and AER maps looks like the following. The formula or render engine used for lighting calculations must be exactly the same as rendered engine used for rendering the volume cube and for transforming the volume into the AER maps.
1. Computing lighting of the surface in real-time for each vertex based on existing light source(s).
2. Display surface without AER maps with only real-time lighting included.
3. Display surface with AER map by multiplying existing lighting surface by AER map points.
   Because original surface in real-time are displayed with same lighting as in volume render time, the resulting image shows correct lighting because real-time lighting multiplied by AER map intensity coefficient containing volume render information projected into the map (rendered by same lighting calculations method). There is no need to define additional light sources, existing light sources will give correct result for the shape.

DISPLAYING OUTPUT VOLUME MATRIX: Output volume matrix is a 3D matrix containing pixel color information for each rendered point of the active volume. The displaying process performs the following steps. If the output volume matrix contains only lighting intensity coefficient then:
For each point in the Output volume matrix.
Compute X,Y,Z coordinate of the point by adding I*Δ,J*Δ,K*Δ to Xₘᵢₙ, Yₘᵢₙ, Zₘᵢₙ
Take 3D point value at X,Y,Z
Multiply with existing object texture and material value and display final resulting point If the output volume matrix contains total rendering result color, which includes lighting computed by using existing texture and material information.
For each point in the Output volume matrix.
Compute X,Y,Z coordinate of the point by adding I*Δ,J*Δ,K*Δ to Xₘᵢₙ, Yₘᵢₙ, Zₘᵢₙ
Display 3D point at X, Y,Z

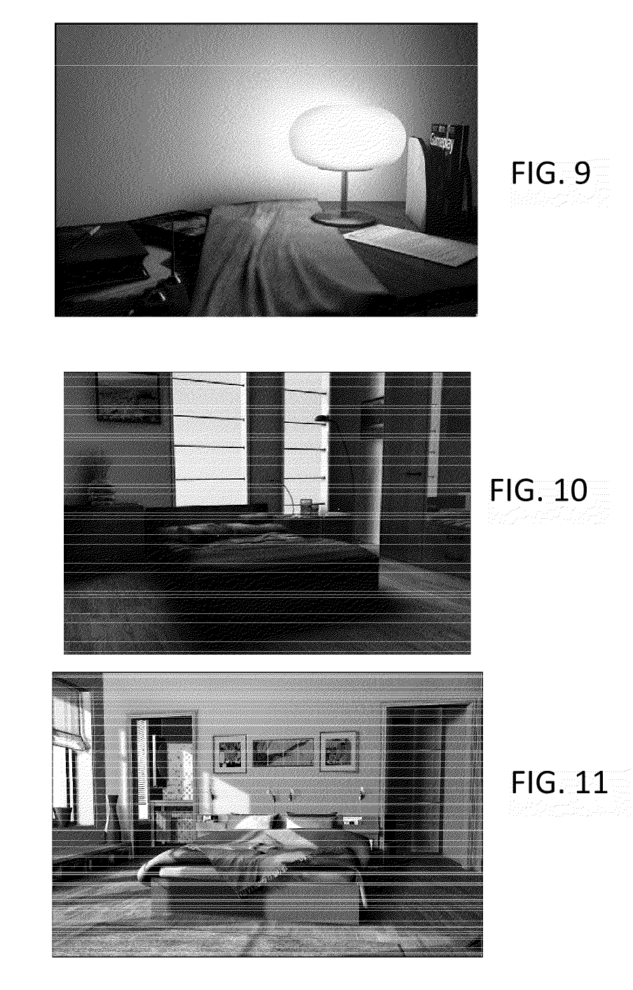

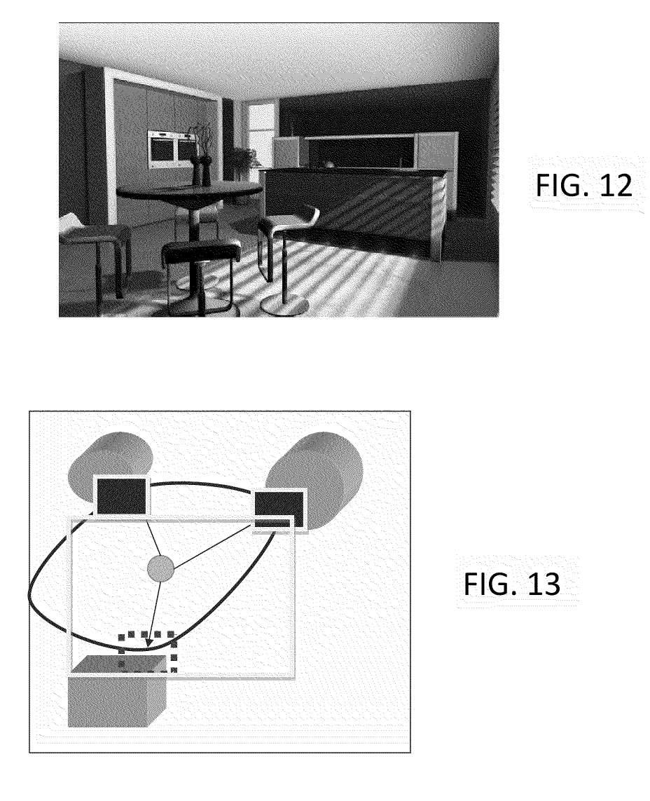

EXAMPLES OF REAL-TIME SCENES RENDERED BY is AER: Volume resolution is 1024×1024×1024. Examples of real-time scenes rendered by the volume cube and displayed by using output volume matrix projected into VR maps are shown in FIGS. 9-12.

OPTIMIZING THE VOLUME BY USING AER CENTER: Defining volume active area is an important task for increasing render speed. There are various methods to finding internal view of the volume. The graph shown in FIG. 13 demonstrates integrated volume shape that defines the active area of the scene. In order to define the optimal active area we must define the possible area of the moving viewpoint. From each possible viewpoint position we must construct a radial shape or HSI (Half Spaces Intersection, see below) shape and calculate surface area of the constructed radial shape. Squares 2 show an active area where integrated radial shapes are attached to the objects in the scene. Line 4 shows radial shape constructed inside the volume from the given viewpoint position. Point 6 defines viewpoint position. Rectangle 8 shows all the possible viewpoint positions.

Because we do not have actual viewpoint in the volume, we will use AER center in order to define optimal active volume.

So we have the following optimization task:
1. Find HSI or Radial figure for VR center—integrated FIG.
2. Calculate surface area of integrated FIG.
3. Move AER center to all possible places defined in transparent green rectangle
4. Find maximum value of integrated shape's surface area
5. Find minimum value of integrated shape's surface area
   The maximum point and minimum point will define active volume most optimal positions for moving AER center.

FIG. 13

The next stage is moving the viewpoint to all possible positions defined by the scene properties and constructing an integrated radial shape that shows how the active area changes.

RADIAL FUNCTION INSIDE THE VOLUME: The Radial Function can return more than one value for non-convex shapes. The “true value” of Radial Function is the minimum of all values—like in the case of 2D. In our is the polygons (convex and non-convex) have facets that are considered as a union of triangles. We perform the calculation of Radial Function in the following steps:
1. Consider next facet of a polygon
2. Calculate intersection point of radial line and the plane of the facet
3. Check whether the intersection point is inside the facet. If “yes” then one of values of Radial Function is found
4. Repeat steps 1, 2, 3
5. Get the minimum value (true value) of the found set of values

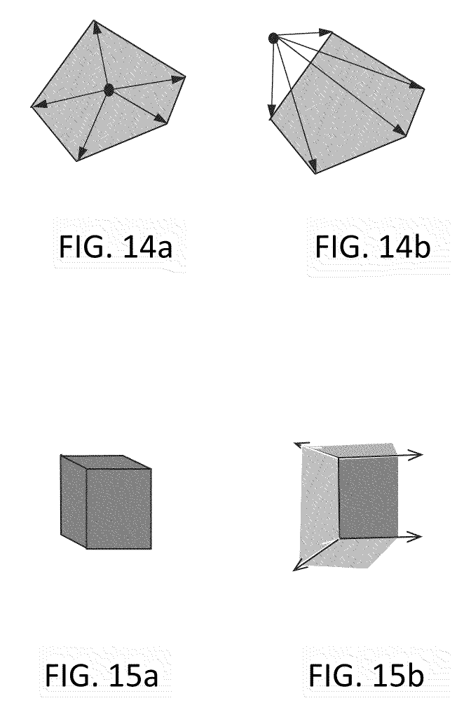

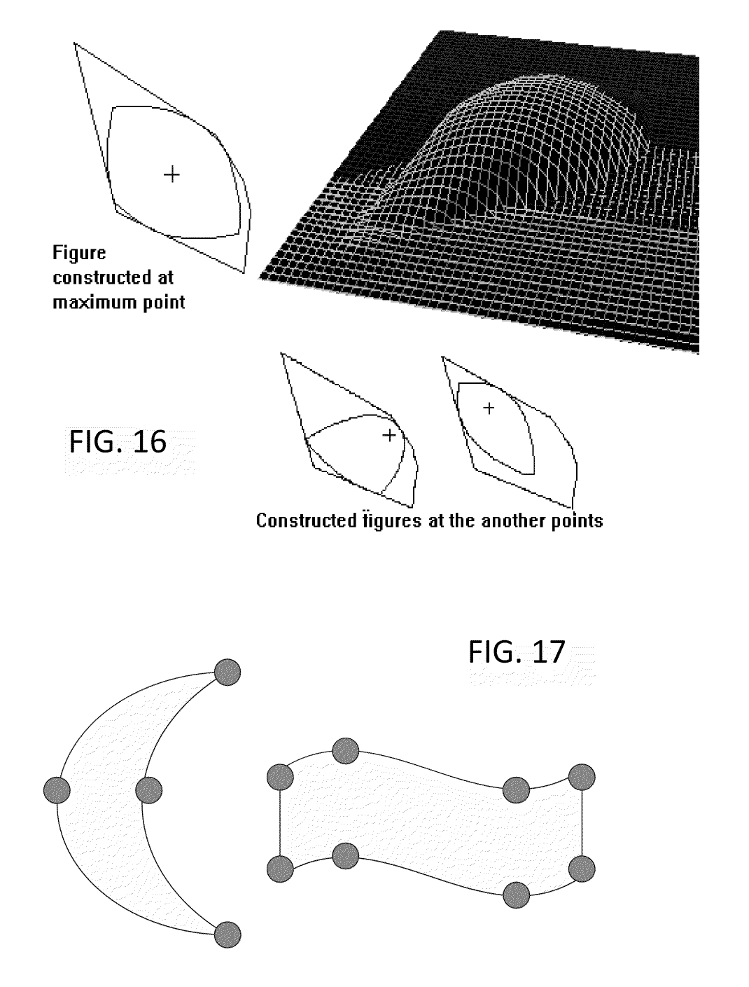

Checking of intersection point towards the facet (step 3) is an interesting aspect to be considered here. For a convex facet the checking is realized as follows: Connect the intersection point with the vertices of the facet and get a list of sequentially placed vectors. Get sum of vector multiplication of all two adjacent vectors (one can state that this sum is twice the area of the facet). If sum/2 is equal to the facet area then the point is inside the facet. FIG. 14 shows this process. FIG. 14(a) shows the intersection point inside while FIG. 14(b) shows the intersection point outside or non-convex facets is it necessary to subdivide the facet into triangles and repeat the procedure of checking for each triangle.

HALF-SPACE INTERSECTION CALCULATION: If HSI is a finite shape the algorithm gives vertices of the shape. In the case of infinite region the algorithms gives vertices and border planes. The algorithm accelerates the calculation 5-6 times if the half-planes are sorted by rotating vector. As distinct from 2D, the sorting of half-spaces in 3D does not lead to any improvement in computational speed. In the case of 2D, a priority is considered that a line intersects HPI at two points at most. In the case of 3D we can safely consider that an intersection of HSI and a plane—the intersection—will have a set of lines. Obviously, the number of lines is varied.

Below we give the rules that are used in the procedure of the algorithm.
Rule 1. HSI is always a convex region.
Rule 2. Any infinite or finite HSI involves convex facets that in their turn appear as HPI in 2D (finite or infinite). While in the case of finite HSI, apparently, facets are finite HPI on a plane.
Rule 3. So, one can say that a finite HSI consists of edges (see FIG. 10(a)).
Rule 4. Infinite HSI finally consists of half-lines and edges (see FIG. 10(b)).
   FIG. 15(a) shows a finite HSI and FIG. 15(b) shows an infinite HSI.

Cutting an HSI by a new plane (with direction corresponding to the half-space) we get a new facet—intersection of the HSI and the new plane. This new facet can be finite or infinite. To analyze this new facet one has to find those other facets of a given HSI that intersect the plane of the new facet. Let those other facets be considered as cutting facets. The half-spaces of the cutting facets can be projected on the new plane, as a result we will get the half-planes list on the given plane. After getting the half-planes list we should compute the HPI figure on the new plane, as a result new facet (finite or infinite) is found (see FIG. 16). FIG. 16 also shows an optimization process for the volume, the resulting graph displays how the volume is changed. The figure displayed is the scene bounding shape. The figure inside is the HSI shape defining active area of the volume from the AER center.

SAVING RENDERED VOLUME CUBE: Saving render volume cube allows saving disk space.
1. No need to store object polygon and vertex information because it is included in the volume, except the interactive objects
2. No need to store textures information, if render includes complete lighting result with material and texture information.
3. No need to store whole volume, just active parts of it
4. We can use JPEG compression for each active part of volume, store it as JPEG layer

ADAPTIVE 3D COMPRESSION: In conjunction with and as a part of ia AER to reach a global understanding of any given 3D environment, ia also employs its Adaptive 3D Compression engine. The major aspects of this engine are:
1. To find similar objects in the scene and formulate transferring of one object to another
2. To find alternate ways to describe the shapes by using computational geometry functions
3. To use external 3D objects database to store only indexes of the objects in the 3D scene
4. To use individual priority of each 3D object in order to perform more efficient texture compression

The Adaptive 3D Compression method performs strong analysis of entry scene and finds the following factors:
3D compression is independent from the program where original scene was created; it works with any imported set of 3D objects and textures, where 3D objects are defined as set of vertices and polygons including texture data
3D compression is designed to analyze a 3D scene if there is no information about transformation matrices and formulas by which the shapes were created
3D compression parses the scene to find all similar objects and to generate transformation matrices
3D compression parses the scene by all objects which are possible to describe by Half Spaced Intersection or Radial functions for reconstruction method
3D compression will link the scene to 3D objects database, by checking similarity of objects from the scene to the objects from database and generate indexes of the objects
3D compression will define importance level of objects for using in texture optimization process. Importance factor checks how much the object is accessible to potential viewer and what the role of the object is in the scene. The importance factor may also be defined by the user

INPUT DATA FOR ADAPTIVE 3D COMPRESSION: 3D scenes in computer graphics not only store models (objects), but it also contains sets of textures and/or light maps. So the Adaptive 3D Compression method suggested by us, is designed to fully include all 3D space information—vector graphics and textures located on objects. The method of data compression, which is based on analyzing incoming data as a 3D virtual space description or data, may be interpreted as follows: 3D Scene
1. Set of objects where each object has certain number of vertexes and polygons
2. Each polygon contains N number of vertexes located in single plane referred to formula A*x+B*y+C*z+D=0, where A,B,C is a normal vector of a polygon
3. Each vertex is described by X,Y,Z coordinates
4. Each object has material and texture information, which is compressed separately

2D Scene
1. Set of objects where each object has 2D vertexes and lines.
2. Each line contains 2 vertexes located in single line referred to formula A*x+B*y+C=0, where A,B, is a normal vector of a line
3. Each vertex is described by X,Y,Z coordinates.
4. Each object has material and texture information, which is compressed separately
   Input data is not a real 3D scene; it can be converted or interpreted as a 3D space object. However the method is working well and specially designed for 3D and 2D scene compressions used in 3D or 2D vector programs. This method allows storing huge amounts of visual data in the lowest possible sizes.

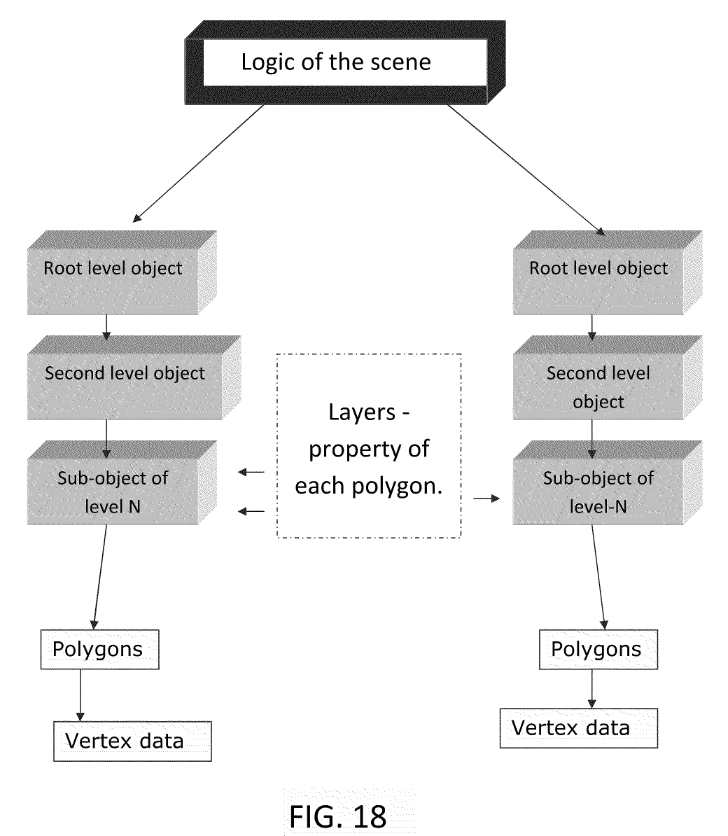

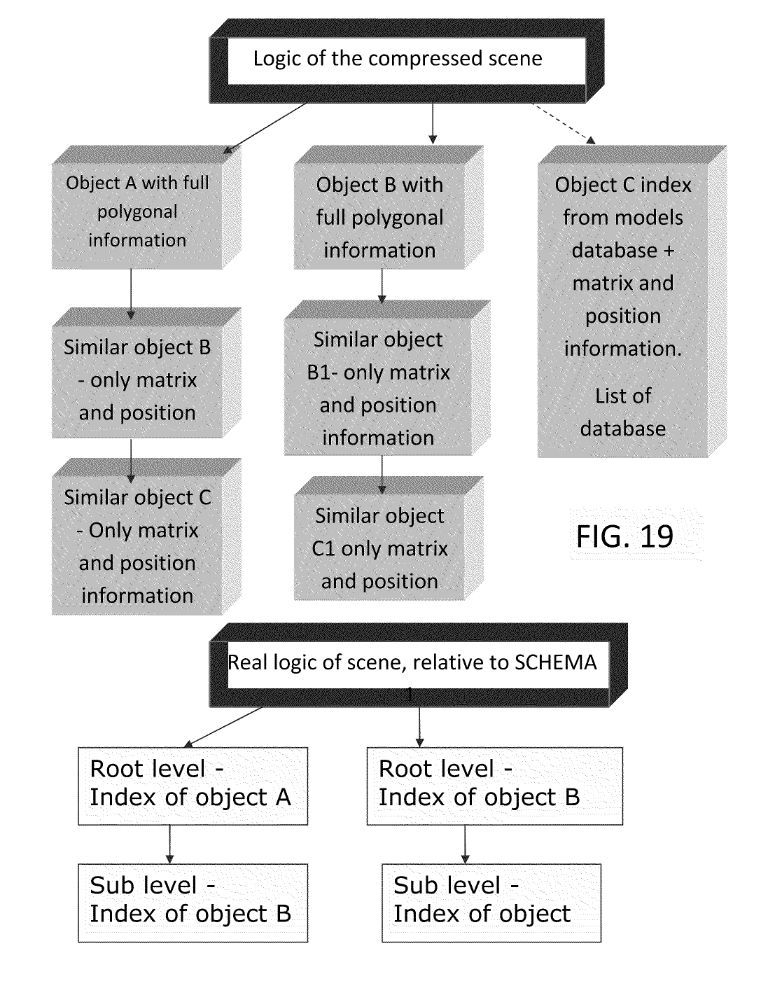

Any given 3D scene however has a logical structure, where each object may have its sub-objects. However, the 3D compression of the present invention is a method of analyzing this logical structure to reproduce it in a compressed state. The diagram of FIG. 18 discloses this logical structure.

METHOD OF ADAPTIVE 3D COMPRESSION: is Adaptive 3D Compression method is based on both object recognition methodology and on object compression methodology. Definitions:
Bottom Level Object (BLO)—is an object which does not have any sub-objects and sub-groups in its logical organization.
Objective Point—is a set of points which describes the style of a geometrical shape in formal understandable way for visual analysis. The following diagram shows what are objective points for a 2D object.

Recognition of 3D object based on the following:
1. Get the BLO object
2. Find objective points (NEW DEFINITION FOR 3D COMPRESSION) of objects, this is the method suggested by us.
   Objective Point shape is a point located at the extreme points and on fracture points of the shape's outline.
3. Find polygons located around Objective Points, these polygons are formally named as Objective Polygons, and useful only for 3D objects.
4. Find objects in database, where number of Objective Points is close to some fixed coefficient to the original BLO.
5. Solve lineal equation for each Objective Polygon of BLO and Objective Polygons of DB object. The method then finds transformation matrix which transforms original BLO to a database object. After applying matrix 2 objects are compared by processing its vertexes relative positions around mass center of object. For example if vertex 1 located from mass center by radial position angle A and length M and vertex 2 located by angle A+X % of A and Length M+X % of M, in this case we have description of vertex 2 relative to vertex 1. Same process is implemented to vertexes located at similar angle A in the original BLO and similar A+X. Differences between numbers percentage of A (angle) and percent of (M) by ignoring the actual length, defines how much one object differs from another. Average sum of percentage differences between A and M defines coefficient of difference.
6. Repeat step 5 for each Objective Polygon and find transformation matrix with minimal difference result. If the difference result or 0 then objects are found in the database, if not, then check difference result with Minimum Allowed difference coefficient is entered by user.
7. If object is found in the database it will then store only the index of the DB object and its transformation matrix.
8. If object is not found in database then use steps from 1 to 7 to find similar objects in existing scene, in this case all BLO are checked first, then each higher group of objects is checked together etc, until we will find that object A is similar to object B in the same scene by difference coefficient X and transformation matrix M.
9. If similar objects are found, then the right polygonal data of the first object found is stored and only transformation matrices and position information of other similar objects.
   The following diagram shows compressed scene logic.

ia HARDWARE ACCELERATOR: As part of ia AER a final component is the ia Hardware Accelerator. Video cards and other hardware solutions that allow increasing speed of rendering are based on integrated algorithms that are interpreted directly by processors inside the hardware. In fact, each accelerator is a computer with integrated algorithm, which implements calculations on hardware level. This means that each hardware-based acceleration is dependent on algorithm and the solution available on the hardware platform. This however does not provide a universal solution and therefore there is always a degree of dependency from the hardware (video card) manufacturers.

In order to initiate a comprehensive and working solution that is independent of hardware, ia has set to use common hardware objectives. Any given hardware has specific objectives, and the final objective of any video hardware is visualization. So, common parameter of any video or visualization hardware is “showing an image” on some output device. We do not delve into HOW an image is shown, but any visualization hardware ultimately shows an image. Even printing system is also a system that shows an image on paper. So when speaking about visualization hardware we including in it video cards, printers, projectors and all other hardware that receives some digital input in order to produce an output image.

In order to make an independent solution, we are using software that uses only minimal common objective of any visualization hardware, which is “showing an image”. Images are constructed by various independent ways and means, outside of the hardware and integrated hardware algorithms are NOT used.

ia Hardware Accelerator uses maximum output speed of any given hardware. ia Hardware Accelerator is a method, which utilizes and employs the maximum speed of the video card installed on the host computer in order to show the 3D static scene, without using any additional hardware calculations. Again, this is based on calculations performed by software algorithm, which is external, however visualization of a result is hardware based, and there is no dependency from hardware algorithm, because we are using minimal common objective of the hardware.

The process is divided into the following parts: (External Independent Algorithm computes initially a single time)
1. ia AER of image
2. Calculation of the lighting
3. Calculation of reflections
4. Calculation of materials
5. Performs total view—independent showing process and generate output lineal list of simple graphical data (point, point color, texture images compatible with minimal common objective of hardware).
   Total view is based on calling of SHOW command for each point of 3D scene, without checking to see if the object is visible on the screen or not. This means that we are transforming the entire 3D volume information to SHOW lineal list of simplest graphical lineal data (SGLD) output.

The next stage is the static 3D scene and defining the matrix for transforming the view to a given camera or viewpoint and send the simple graphical data lineal list to the hardware. Because the hardware does not perform any calculations except simply showing the simple data, it uses its maximum speed for visualization. In fact, what we end up with is a graphical card accelerated image, but having the volume of the image computed outside of the graphical card.

ia Hardware Accelerator Layers or MULTI SGLD. 3D scene can be defined into different Layers or Zones, where each zone can be computed with a separate Turbo Amplifier SGLD.

Because visualization of each SGLD uses transformation matrix, it means that different zones can be rotated or scaled or transformed by the matrix in other ways. This allows adding more dynamic objects in SGLD, which is in fact, are purely static computed data.

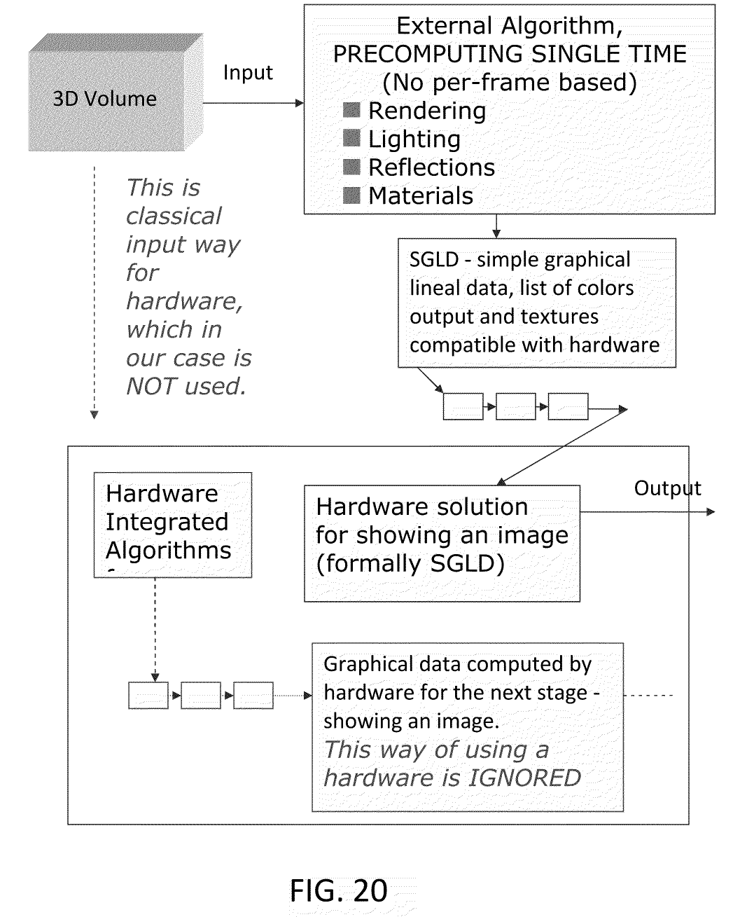

The diagram of FIG. 20 demonstrates the concept including parts that show the classical approach.

Changes and modifications to the embodiments chosen and described for purposes of illustration will readily occur to those skilled in the art. To the extent such modifications and variations do not depart from the spirit of the invention, they are intended to be included within the scope. The scope of the invention must be assessed only by a fair interpretation of the following claims.

We claim:

1. A method of creating an interactive atmosphere active environmental rendered 2D video representation of a 3D scene, comprising the steps of:
a. accessing data representing a 3D environment from a 3D perspective;
b. calculating a 2D video representation utilizing volumes from the entire 3D environment by;
i. creating a single 3D output matrix with no light-map; and
ii. changing the output matrix.
